(19) United States
(12) Patent Application Publication
(10) Pub. No.: US 2012/0091869 A1
(43) Pub. Date: Apr. 19, 2012

(54) RETAINING AN INTERFACE ON AN AUTOMATED PRODUCT DISPSENSER

(75) Inventor: Pascal Vandromme, Castelnau le Lez (FR)

(73) Assignee: VANEXPORT, Castelnau le Lez (FR)

(21) Appl. No.: 13/318,102

(22) PCT Filed: Apr. 28, 2010
(86) PCT No.: PCT/FR10/50801

§ 371 Date: Oct. 28, 2011

(30) Foreign Application Priority Data
Apr. 30, 2009 (FR) 0952905

(51) Int. Cl. B42F 21/00

(52) U.S. Cl. 312/234

(57) ABSTRACT

An embodiment of the present invention relates to an automated device for dispensing products, including a housing accessible via an opening hinged on a sleeper and made of a frame bearing a flexible polycarbonate plate. The housing also includes an interface for display and input by a user, and the opening includes a rigid mechanism for retaining the interface onto the frame, in the form of junction mounts that make it possible to place the interface on the front surface through an opening having a corresponding size and formed in the plate.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention falls within the field of the automated dispensing of consumer products, namely food products.

2. Description of Related Art Including Information Disclosed Under 37 CFR 1.97 and 37 CFR 1.98.

In general, such products are stored in dispensers, often cooled for preserving the products. The dispensing of the products occurs automatically by self-service through an interface permitting the user to select and pay for the product he wants before the latter is delivered to him.

In particular, said interface comprises means for selecting the chosen product, namely through an alpha-numerical keyboard permitting the user to input the reference number corresponding to the product. The interface also comprises payment means in the form of a currency detector, often for coins.

In addition, such a dispenser comprises a front, serving as a support for displaying and visualizing advertisement. This front face is formed of a leaf hinged, which is pivotally mounted on a sash-frame, so as to form a door for allowing the supply and the maintenance of the dispenser. Said front face also comprises a plate, which is mounted on said sash-frame, and hiding the central space of the latter. This plate is often curved, domed towards the front.

Generally, said plate is backlit by means of lamps located inside the enclosure of said dispenser. In addition, a display is arranged on the inner side, such as a poster that lets the light through, in order to filter the light, or directly fixed to the plate.

An example of such a dispenser is described in WO 96/33477, which possesses an enclosure on which, on the one hand, is mounted on the front face, on hinges, a door provided with a curved rigid plate and, on the other hand, are present selection and payment means on the right-hand portion of the front wall.

On such a device, the curved plate has a recess provided for receiving a product-spending trap door, this trap door being connected to and integral with the enclosure, like all the elements enclosed in same.

Another example of a spender is described in U.S. Pat. No. 5,255,968, with the difference that the selection and payment means are integrated into the hinged door. In addition, such a dispenser has a plate made out of translucent and rigid material, such as a polymer, improving the strength and sturdiness, in order to reinforce the door against breakage, limiting the risks of vandalism and the intrusions.

Further documents are related to similar dispensers and try to solve the problems of burglary at the level of the door in the front wall, such as in EP 0 980 054, through profiles having a particular shape and forming the door-frame and the sash-frame of the door, or facilitating the replacement of the front wall, such as in U.S. Pat. No. 4,320,933, through two superimposed doors at the front and removable with respect to each other, permitting, as the case may be, to replace the outer door supporting the plate or the inner door provided with the electronics.

Another solution is contemplated through WO 2005/106825, which describes a dispenser the front face of which is designed removable, facilitating its replacement et permitting to change them periodically, namely for esthetical reasons.

These existing dispensers offer different alternatives, but are not fully satisfactory, because of their prohibitive cost price and their manufacturing complexity.

### SUMMARY OF THE INVENTION

A solution has been found through a front-wall front plate made out of a specific material.

Indeed, in the meaning of the present application, said plate is made out of a transparent material, such as polycarbonate. Besides its translucent aspect, this material offers the advantage of having a high impact strength as well as a high perforation strength, and has mechanical flexibility characteristics.

A front face of the dispenser provided with a plate made out of polycarbonate thus provides a good-quality display space, for increased safety, which protects against eventual breakage, vandalism or intrusions.

The invention will thus find its application in an automated dispenser provided with such a front face made out of polycarbonate.

Indeed, there has been devised to offset or to add the interface for interaction with the user at the level of said plate. However, the integration of the interface at the level of the plate made out of flexible polycarbonate raises problems relating to its retaining.

Therefore, the invention provides an automated product-dispensing device comprising a rigid structure for integrating, at the level of the flexible plate made out of polycarbonate, an interface for interaction with the user.

Such a device comprises an enclosure accessible through a leaf mounted hinging on a sash-frame and formed of a frame for supporting a flexible plate made out of polycarbonate, said enclosure also comprising a display and user-input interface, wherein said leaf comprises rigid means for retaining said interface on said frame in the form of junction mounts permitting to arrange the interface on the front face through an opening having a corresponding size provided for in said plate.

Therefore, the invention permits to arrange at any location of the front plate an interface by making same integral with the door, without degrading the advantages of strength and safety provided by the polycarbonate of said plate.

Further features and advantages of the invention will become clear from the following detailed description of the non-restrictive embodiments of the invention, when referring to the attached figures.

### BRIEF DESCRIPTION OF THE DRAWINGS

FIG. 1 represents a schematic perspective view of a dispensing device according to the invention.

FIG. 2 is a perspective view from inside of the front face of such a device.

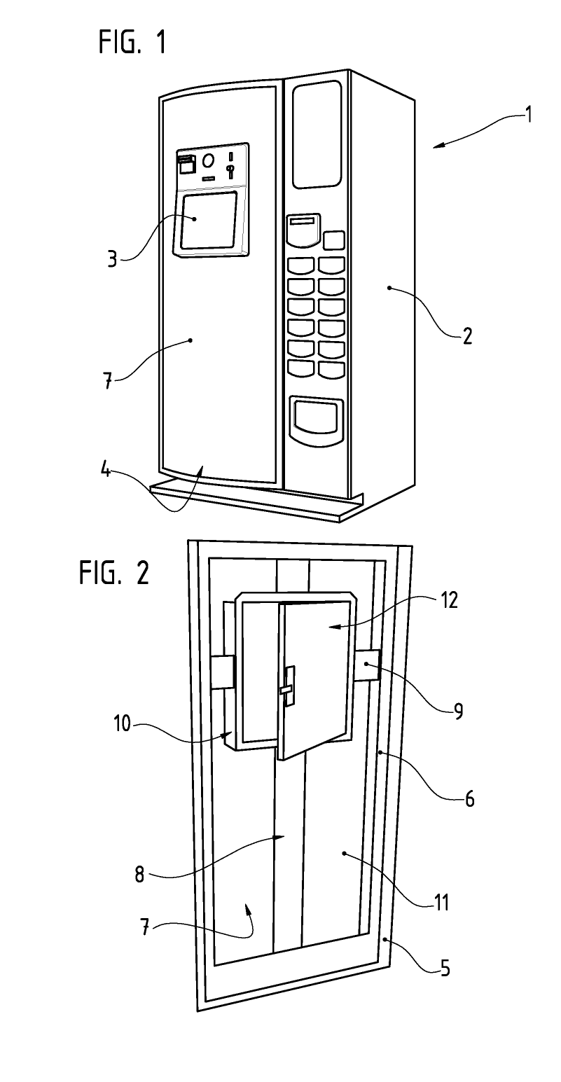

### DETAILED DESCRIPTION OF THE DRAWINGS

The present invention relates to an automated product-dispensing device 1, in particular for consumer products, namely food products.

Such a dispensing device 1 comprises an enclosure 2 enclosing an automate and means for storing said products.

Said enclosure 2 is accessible through a leaf mounted hinging on a sash-frame 5. Such a hinging can be provided in vertical rotation, like a door, or in vertical rotation, like a canopy. In addition, said leaf is provided with a frame 6 supporting a plate 7. The latter is flexible, made out of polycarbonate.

It should be noted that this plate serves as a display, namely for visual media. It is preferably backlit by lamps 11 located inside said enclosure 2.

Said automate (not shown) permits to deliver the product chosen by a user, upon payment by the latter.

To this end, said dispenser 1 comprises a display and user-input interface 3. Such an interface can be formed of one or several elements arranged independently at the level of either of the outer walls of said enclosure 2, in particular on the front face 4.

In addition, said interface can integrate any kind of payment means, such as a currency detector. It also integrates input means, such as an alpha-numerical keyboard, for selecting an identifier corresponding to the product chosen by the user.

According to the preferred embodiment, said interface also comprises at least one display and/or input screen, namely such as a touch screen.

Advantageously, said leaf comprises rigid means for retaining said interface 3 on said frame 6. In particular, said means for retaining comprise mounts for joining said interface 3 to said frame 6. Such mounts permit to arrange the interface 3 on the front face 4, namely through an opening, having a corresponding size, provided for in said plate 7. Therefore, the interface 3 becomes accessible for the user from the outside, in particular the input space, such as the touch screen. However, at least the whole or part of said interface 3 can remain enclosed, protected inside said enclosure 2.

It should be noted that a seal can be provided for between said interface 3 and the edges of said opening in the plate 7.

In particular, said interface 3 can be integrated within a casing 10 integral with the end of each mount. The junction between said casing 10 and each mount can be made by removable fastening means, through screwing or encasement, but also directly through welding.

According to one embodiment, said fastening means are in the form of a fixing plate integral with the end of the mount at the level of the junction with said interface 3, namely into contact with the casing 10. Such a fixing plate extends orthogonally with respect to the longitudinal axis of said mount, parallel to the outer wall of said casing 10.

Bores can be provided through each fixing plate, in front of openings provided for through the corresponding wall of said casing 10. These bores and openings are aimed at receiving fastening means, such as pins, a pair of screw and nut or the like.

Furthermore, a counter-plate can be fixed inside said casing 10, superimposed on said fixing plate on the other side of the wall of the casing 10. Therefore, said fixing plate or said counter-plate can comprise pins passing through said openings in the wall of the casing 10, so as to cooperate through encasement with said counter-plate or said fixing plate, respectively.

Furthermore, according to another embodiment, each fixing plate can comprise a curved edge. In particular, this edge can have an inclination so as to enter into contact with the inner surface of the plate 7. This inclination is oriented according to the curvature of said plate 7. Thus, each fixing plate forms a reinforcement behind the plate 7 at the level of the opening through which passes said interface 3, thus offering a better resistance to deflection at that location and to eventual tearing of the plate 7, at the level of the opening, due to stresses it is subjected to and to ageing.

It should be noted that said casing 10 can have, on its rear face, a trap door 12 for accessing the mechanics and the electronics of the interface 3.

Besides retaining the interface 3, said mounts permit to further rigidify the structure of the leaf.

In this respect, said mounts can be made out of any kind of material, but preferably out of metal, so as to provide better rigidity and strength. They can have any kind of cross-section, but, according to the preferred embodiment, each mount is formed of a U-shaped metal profile the free ends of the legs of which are curved. Such a profile can be achieved through extrusion, deep-drawing or the like.

In addition, according to a preferred embodiment, each mount can be formed of at least two lengths, which are telescopic with respect to each other. TO this end, a first length is designed hollow, so as to slidably receive a second length, having a complementary, but smaller cross-section. This sliding permits to accurately adjust the location of the interface 3 with respect to said opening in the plate 7.

In particular, the adjusting of the lengths with respect to each other can be blocked, namely through screwing-in or the like.

This sliding feature also permits the expansion of the metals during changes in temperature.

In addition, said mounts comprise at least a longitudinal beam 8 and or a cross-beam 9 connected at each of their ends, on the one hand, to said interface 3 and, on the other hand, to said frame 6.

According to the preferred embodiment, as can be seen in FIG. 2, said mounts comprise two longitudinal beams 8 and two horizontal cross-beams 9, each connected to said interface 3 and to said frame 6, on both sides of said interface 3.

The invention thus permits to place a interface for interaction with the user directly at the level of the flexible plate 7 made out of polycarbonate of a product dispenser, while improving the rigidity of the leaf and providing a better strength at the level of said plate 7.

Of course, the invention is not limited to the examples shown and described above, which may have variants and modifications without departing from the framework of the invention.

1. Automated product-dispensing device, comprising:
an enclosure accessible through a leaf mounted hinged on a sash-frame and comprised of a frame supporting a flexible plate comprised of polycarbonate, said enclosure also comprising a display and user-input interface,
wherein said leaf comprises rigid means for retaining said interface on said frame comprised of junction mounts permitting to arrange the interface on the front face through an opening having a corresponding size provided for in said plate.

2. Device according to claim 1, wherein said mounts comprise at least one longitudinal beam connected at each end thereof, one end to said interface and another end to said frame.

3. Device according to claim 1, wherein said mounts comprise at least one cross-beam connected at each end thereof, one end to said interface and another end to said frame.

4. Device according to claim 1, wherein each mount is comprised of at least two lengths, which are telescopic with respect to each other.

5. Device according to claim 1, wherein said interface is integrated within a casing integral with the end of each mount.
